(19) United States
(12) Patent Application Publication
(10) Pub. No.: US 2016/0134128 A1
(43) Pub. Date: May 12, 2016

(54) ADHESIVE WIRELESS POWER SUPPLY APPARATUS

(71) Applicant: SNAILFIX Co.,Ltd., Goyang (KR)

(72) Inventor: Kwang Bok KO, Yangju (KR)

(21) Appl. No.: 14/562,664

(22) Filed: Dec. 6, 2014

(30) Foreign Application Priority Data
Nov. 6, 2014 (KR) 10-2014-0153842
Nov. 7, 2014 (KR) 10-2014-0154595

(51) Int. Cl. H02J 5/00; H02J 7/02; H02J 17/00

(52) U.S. Cl. CPC H02J 5/005; H02J 17/00; H02J 7/025

(57) ABSTRACT

Provided is an adhesive wireless power supply apparatus. The apparatus includes: a power transmission unit including a power transmission coil to generate an induced power in a power reception coil provided in a power reception body and a circuit board, in which the power transmission coil is mounted, supplied with power from an external, and provides power to the power transmission coil; and a viscous sheath which is formed to surround the outside of the power transmission unit, is made of a material having viscosity and elasticity, is adhered to the power reception body due to an inherent viscosity, and enables the power transmission unit to be adhered to a mounting surface.

### CROSS-REFERENCE TO RELATED APPLICATION

This application claims priority under 35 U.S.C. §119 from Korean Application No. 10-2014-0153842 filed on Nov. 6, 2014 and Korean Application No. 10-2014-0154595 filed on Nov. 7, 2014, the subject matter of which is incorporated herein by reference.

### TECHNICAL FIELD

The present invention relates to a wireless power supply apparatus, and more particularly, to an adhesive wireless power supply apparatus that can supply power to various objects, such as a mobile phone or a lamp, which are adhered in various locations, and improve a power supply efficiency by preventing an arrangement of the wireless power supply apparatus and a power reception body from being disturbed.

### BACKGROUND

Recently, a smart phone has been widely used, and a user of the smart phone may perform an internet access, a video call, and various working with documents as well as a voice call.

However, when various functions are performed, such a smart phone with a large display screen may encounter a rapid exhaustion of battery. Accordingly, a demand for a device that can conveniently charge the smart phone is also increased.

A generally used charging method is a method of connecting a cable of a charger connected to a power source to a socket of the smart phone.

Recently, a wireless charging method, as shown in the prior art (Korea Patent Laid-open Publication No. 10-2011-0068007), has been developed. In the wireless charging method, a charging reception unit connected to a portable terminal such as a smart phone is placed on a charging transmission unit to perform a charging, without setting the portable terminal on a charger, or directly connecting a connector of the charger to a connector of the portable terminal.

An electromagnetic induction type is mainly used for the wireless charging method. The electromagnetic induction type means a method of performing a charging by generating an induced current between two adjacent coils, and uses a principle that the induced current is generated depending on the number of turns of the two coils and a distance between the coils.

Therefore, a method of performing a charging by generating an induced current in a receiving coil as a transmitting coil is disposed in a power supply unit and the receiving coil corresponding to the transmitting coil of the power supply unit is disposed in the portable terminal is used.

In addition, as shown in the prior art (Korea Patent Registration No. 10-0867405), a terminal battery charging device for wireless charging of a battery cell by using a radio frequency of RFID reader has been used.

However, in such a battery charging device, an RFID reader and the battery cells are separated, and, when it is used in a moving space like a vehicle, the RFID reader and the battery cell may be separated, thereby stopping the supply of power.

Further, in the wireless charging device, the arrangement of the transmitting coil and the receiving coil should be accurately disposed, and, if the arrangement is disturbed, the efficiency may be sharply reduced.

Therefore, it may be used only in a limited place, such as desk, and is difficult to use in a vehicle having a serious vibration. Further, even when it is used in a desk, if the portable terminal is accidently jogged or nudged by user, the arrangement is immediately disturbed to stop charging.

In addition, since the portable terminal is placed on an upper portion of the wireless charging device, it cannot be set in a desired location. Hence, the portable terminal should be laid on the desk or a floor when user wants to simultaneously use the portable terminal for a long time, for example, to watch movies while charging.

### SUMMARY

The present invention may provide an adhesive wireless power supply apparatus in which an arrangement of coils of a power receiving body and a power supply unit is not disturbed.

The present invention further provides an adhesive wireless power supply apparatus which can be adhered to various locations, and can be set in a posture and angle suitable for charging a portable terminal.

In accordance with an aspect of the present invention, an adhesive wireless power supply apparatus includes: a power transmission unit including a power transmission coil to generate an induced power in a power reception coil provided in a power reception body and a circuit board, in which the power transmission coil is mounted, supplied with power from an external, and provides power to the power transmission coil; and a viscous sheath which is formed to surround the outside of the power transmission unit, is made of a material having viscosity and elasticity, is adhered to the power reception body due to an inherent viscosity, and enables the power transmission unit to be adhered to a mounting surface.

The viscous sheath has a shape of cylinder. A groove in which a cable to supply power to the power transmission unit is wound on an outer periphery of the viscous sheath.

A viscosity of a surface of the viscous sheath in contact with a mounting surface is implemented to be stronger than a viscosity of a surface of the viscous sheath in contact with the power reception body.

The apparatus further includes a base in contact with one surface of the viscous sheath and a cover provided to open or cover the other surface of the viscous sheath.

A corona treatment is performed or a primer is coated on the surface of base in contact with the viscous sheath.

The apparatus further includes a first fix panel provided in any one of an outer surface of the base or the cover, and includes an insertion unit penetrating a surface; and a second fix panel includes one side unit including a fastening unit that is detachably coupled to the insertion unit and the other side unit adhered to the mounting surface.

The insertion unit includes: a first inlet and a first protrusion unit when the fastening unit corresponds to the first inlet; and a second protrusion unit which is inserted into the insertion unit through the first inlet and rotates to be coupled to the first protrusion unit.

The second fix panel includes a protuberance which is elastically deformed, and one side of the first fix panel includes a guideline that guides movement of the protuberance and a fixing hole to stop a rotation of the protuberance.

In accordance with another aspect of the present invention, an adhesive wireless power supply apparatus includes: a power transmission unit including a power transmission coil to generate an induced power in a power reception coil provided in a power reception body and a circuit board, in which the power transmission coil is mounted, supplied with power from an external, and provides power to the power transmission coil; and a viscous sheath which is formed to surround the outside of the power transmission unit, and is made of a viscous polyurethane having viscosity and elasticity, wherein a heating temperature is lower than a heat resistant temperature of the power transmission unit 110 when the viscous polyurethane is moulded.

The viscosity polyurethane is formed through a polymerization of a main material including a polyol that has at least two hydroxyl groups per one molecule and a hardener that contains an isocyanate compound, and the content of the polyol in the main material has a range from 75 weight percent to 95 weight percent, and the content of the isocyanate compound in the hardener 20 has a range from 30 weight percent to 60 weight percent.

The isocyanate compound includes at least one of hexa-methylene-diisocyanate, methylene-diisocyanate, toluene-diisocyanate, and isoprene-diisocyanate.

The main material includes: a first polypropylene glycol that has a molecular weight ranging from 2500 to 3500, and has two hydroxyl groups per molecule, when a content within the main material ranges from 13 weight percent to 40 weight percent; a second polypropylene glycol that has a molecular weight ranging from 2500 to 5500, and has three hydroxyl groups per molecule, when a content within the main material ranges from 40 weight percent to 77 weight percent; a catalyst whose content within the main material ranges from 0.2 weight percent to 12 weight percent; and a chain extender whose content within the main material ranges from 0.1 weight percent to 13 weight percent and a plasticizer as a remainder.

The hardener includes: a toluene diisocyanate whose content within the hardener ranges from 29 weight percent to 49 weight percent; a hexamethylene diisocyanate whose content within the hardener ranges from 32 weight percent to 52 weight percent; and a third polypropylene glycol that has a molecular weight ranging from 2500 to 3500, and has three hydroxyl groups per molecule when a content of third polypropylene glycol within the hardener 20 ranges from 5 weight percent to 20 weight percent, and a plasticizer as a remainder

In accordance with another aspect of the present invention, an adhesive wireless power supply apparatus includes: a power transmission unit including a power transmission coil to generate an induced power in a power reception coil provided in a power reception body, and a circuit board which is equipped with the power transmission coil and provides power to the power transmission coil; and a viscous unit which is provided on at least one of a surface of power transmission unit in contact with a power reception body or a surface of power transmission unit in contact with a mounting surface, is made of a material having viscosity and elasticity, and enables the power reception body to be adhered or the power transmission unit to be adhered to a mounting surface due to an inherent viscosity.

The viscous unit is disposed on the surface of power transmission unit in contact with the mounting surface, and the apparatus further includes a holder which is provided on a surface of power transmission unit in contact with the power reception body, and is provided to fix the power reception body.

The apparatus further includes a cable to supply an external power to the power transmission unit.

The apparatus further includes a battery compartment which is formed in the power transmission unit, and holds a battery to supply power to a power transmission unit.

### BRIEF DESCRIPTION OF THE DRAWINGS

The objects, features and advantages of the present invention will be more apparent from the following detailed description in conjunction with the accompanying drawings, in which:

FIG. 1 is a perspective view illustrating an adhesive wireless power supply apparatus according to a first embodiment of the present invention;

FIG. 2 is a diagram illustrating a power reception body that can receive a power from the adhesive wireless power supply apparatus of FIG. 1;

FIG. 3 is a side view illustrating an adhesive wireless power supply apparatus of FIG. 1 which is adhered to the surface of a wall and supplies power to a power reception body;

FIG. 4 is a perspective view illustrating an adhesive wireless power supply apparatus according to a second embodiment of the present invention;

FIG. 5 is a cross-sectional view of an adhesive wireless power supply apparatus of FIG. 2 in a wound cable;

FIG. 6 is a diagram illustrating an example of a method of manufacturing an adhesive wireless power supply apparatus of the present invention;

FIG. 7 is a perspective view illustrating an adhesive wireless power supply apparatus according to a third embodiment of the present invention;

FIG. 8 is a perspective view illustrating an adhesive wireless power supply apparatus according to a fourth embodiment of the present invention;

FIG. 9 is a perspective view illustrating an adhesive wireless power supply apparatus according to a fifth embodiment of the present invention;

FIG. 10 is a perspective view illustrating an adhesive wireless power supply apparatus according to a sixth embodiment of the present invention;

FIG. 11 is a perspective view illustrating another adhesive wireless power supply apparatus according to an embodiment of the present invention;

FIG. 12 is a diagram illustrating an example of a base and a cover according to an embodiment of the present invention;

FIG. 13 is a diagram illustrating an example of a base and a cover according to an embodiment of the present invention;

FIG. 14 is a diagram illustrating an adhesive wireless power supply apparatus according to an embodiment of the present invention;

FIG. 15 is a diagram illustrating an adhesive wireless power supply apparatus according to an embodiment of the present invention;

FIG. 16 is a diagram illustrating an installation of an adhesive wireless power supply apparatus according to an embodiment of the present invention; and

FIG. 17 is a diagram illustrating an installation of an adhesive wireless power supply apparatus according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The above and other features of the invention are discussed infra.

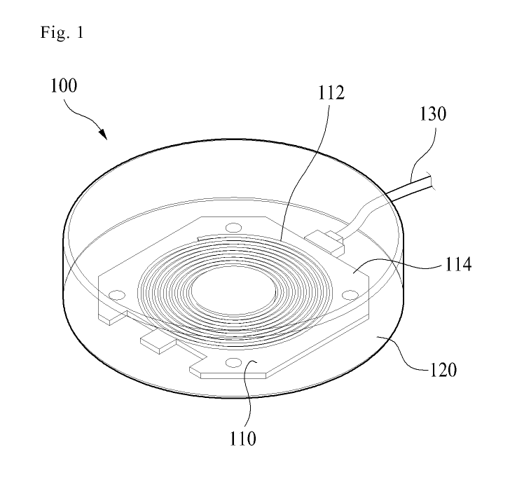

As shown in FIG. 1, an adhesive wireless power supply apparatus 100 according to a first embodiment of the present invention may include a power transmission unit 110 and a viscous sheath 120.

The power transmission unit 110 may include a power transmission coil 112 and a circuit board 114.

The power transmission coil 112 is a component that generates an induced power to a power receiving coil (not shown) provided in a power reception body 190. In the circuit board 114, the power transmission coil 112 is mounted and parts for supplying power to the power transmission coil 112 may be mounted. Further, a cable 130 for supplying an external power to the circuit board may be provided.

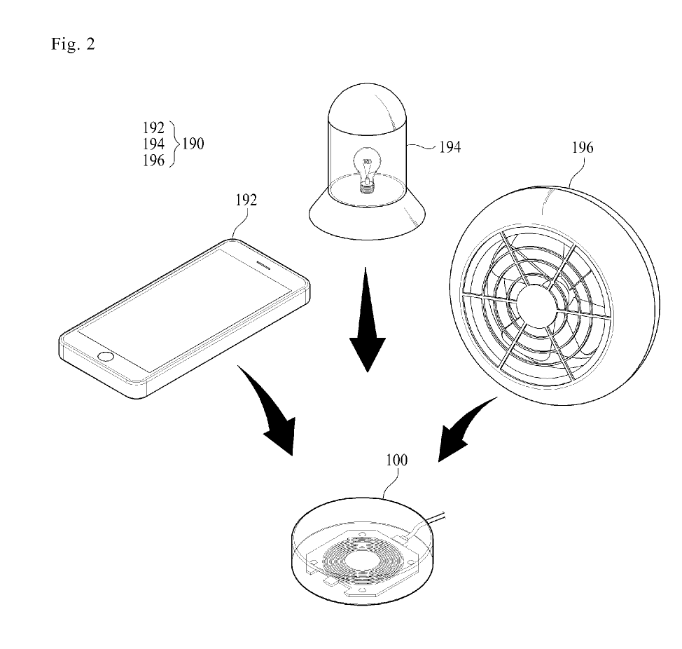

Meanwhile, as shown in FIG. 2, the power reception body 190 may be a portable terminal 192 such as a smart phone, or may be a device actuated by electric energy such as a lamp 194 and a fan 196, or the like.

The power reception body 190 may be provided with a power receiving coil (not shown) in which an induced current is generated by the power transmission coil 112 of the power transmission unit 110.

Therefore, when the power reception body 190 is the portable terminal 192, it can be charged by the power transmission unit 110. In addition, when the power reception body 190 is the lamp 194 or the fan 196, power may be supplied from the power transmission unit 110.

Meanwhile, the viscous sheath 120 may be formed to surround the outside of the power transmission unit 110.

That is, the circuit board 114 and the power transmission coil 112 of the power transmission unit 110 are located in an interior of the viscous sheath 120 to be sealed.

The viscous sheath 120 is made of a material having viscosity and elasticity, such as polyurethane, and may be adhered to the power reception body 190 due to inherent viscosity. Further, the power transmission unit 110 may also be adhered to a wall or a tabletop, or may be adhered to a mounting surface such as a console of vehicle.

In this case, the viscous sheath 120 may be made of a material that can fix the power reception body 190 due to inherent viscosity and, furthermore, may enable the power reception body 190 to be detached repeatedly.

Accordingly, the power reception body 190 may be adhered to the viscous sheath 120 and be fixed. Further, the arrangement of the power transmission coil 112 and a power receiving coil (not shown) may not be disturbed.

In addition, even if a vibration or an unexpected external force is applied, a disturbance of the arrangement of the power receiving coil (not shown) and the power transmission coil 112 may be prevented, so that the adhesive wireless power supply apparatus 100 can be used stably in a place, such as a vehicle, to which a vibration or an external force is exerted at all times.

Meanwhile, the viscous sheath 120 may have a shape of a cylinder. Obviously, the present invention is not limited to the viscous shell that is formed of a cylindrical shape, but may be implemented in various forms. In a description of the present embodiment, it is illustrated that the viscous sheath 120 is implemented in a form of cylinder with a low height, similarly to a pad.

Thus, if the cable 130 is wound around the viscous sheath 120 when the adhesive wireless power supply apparatus 100 is not used, the cable 130 can be adhered to the circumference of the viscous sheath 120 due to the viscosity of the viscous sheath 120, such that the adhesive wireless power supply apparatus 100 can be conveniently kept.

In this case, the viscosity of a surface of the viscous sheath 120 in contact with a mounting surface may be implemented to be stronger than the viscosity of a surface of the viscous sheath 120 in contact with the power reception body 190.

Therefore, when the power reception body 190 adhered to the viscous sheath 120 is detached, the adhesive wireless power supply apparatus 100 may be prevented from being removed from the mounting surface together with the power reception body 190.

In addition, since the power transmission unit 110 is sealed in the interior of the viscous sheath 120 with elasticity, the power transmission unit 110 may be protected from a shock and a vibration exerted from the outside.

Further, since the power transmission unit 110 is composed of electronic elements, it may be vulnerable to direct sunlight, high temperature, or humidity, or the like. However, the power transmission unit 110 may be protected from direct sunlight, high temperature, or humidity, or the like, as it is sealed in the inside of the viscous sheath 120.

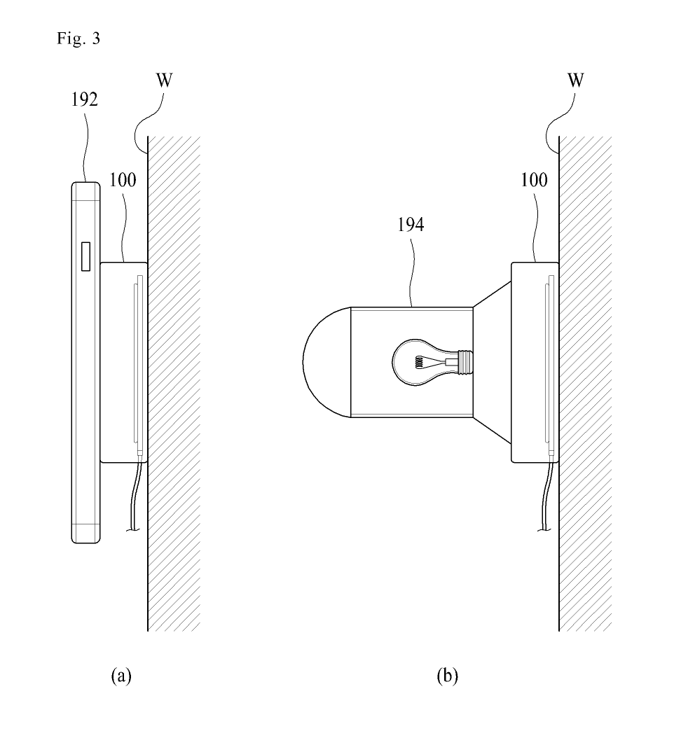

Further, as shown in FIG. 3, since the power transmission unit 110 can be adhered to a wall (W) or a ceiling as well as a table due to the viscosity of the viscous sheath 120, the smart phone 192 may be simultaneously used while it is charged in a more comfortable posture and angle, when the smart phone 192 should be charged while it is used, for example, for watching movie, for a long time. Further, the lamp 194 and the fan 196 may be adhered in a more convenient location to use. That is, the installation of relevant device can be freely performed regardless of a location the relevant device.

In addition, when a child is seated in a back seat of vehicle, a smart phone may be adhered to a headrest or a back of driver seat or passenger seat, so that content for children may be used while the smart phone is charged. Further, during camping, a lamp may be fixed in a proper location to use for a long time while it is charged. Hence, various forms of application can be implemented.

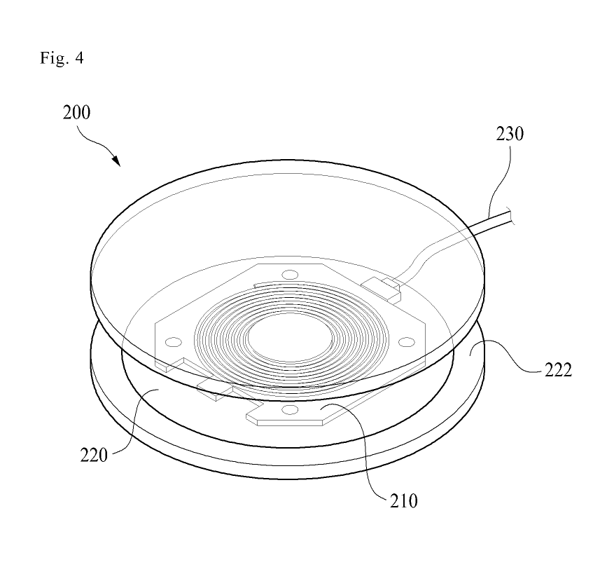

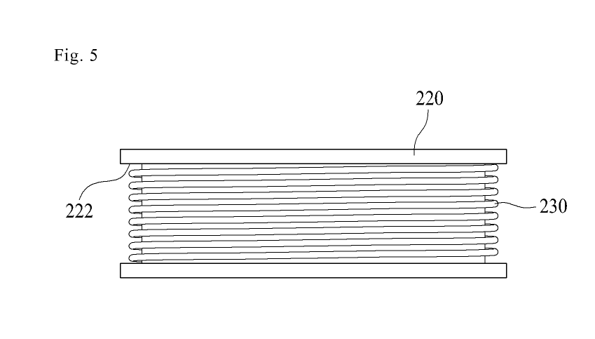

Hereinafter, an adhesive wireless power supply apparatus 200 according to a second embodiment of the present invention will be illustrated with reference to FIG. 4 and FIG. 5.

The adhesive wireless power supply apparatus 200 according to the present embodiment may include a power transmission unit 210 and a viscous sheath 220.

In this case, since the material and the function of the power transmission unit 210 and the viscous sheath 220 are the same as the power transmission unit 110 and the viscous sheath 120 of the above described embodiment, a detailed description is omitted.

The adhesive wireless power supply apparatus 200 according to the present embodiment may have a groove 222 in which a cable 230 is wound on an outer periphery of the viscous sheath 220.

That is, the upper and lower sides of the outer periphery of the viscous sheath 220 may be protruded from the groove 222.

In this case, the cable 230 may be a component which is connected to an external power source and applies the power to the power transmission unit 210.

Thus, when the adhesive wireless power supply apparatus 200 according to the present embodiment is not used, the cable 230 is wound on the outer periphery of the viscous sheath 220 such that the cable 230 is not loosened as it is adhered to the outer periphery of the viscous sheath 220 due to the viscosity of the viscous sheath 220. Further, since the cable 230 is not protruded to the outside of the viscous sheath 220 due to the groove 222, it may be simply kept.

Meanwhile, the viscous sheath 120 may be formed of a material having viscosity and elasticity such as viscous polyurethane. In this case, when the material for the viscous sheath 120 is formed into the viscous sheath 120, a heating temperature may be lower than a heat resistant temperature of the power transmission coil 112 of the power transmission unit 110 and electronic components mounted in the circuit board 114.

Hereinafter, a material for the viscous sheath will be described in detail.

The material of the viscous sheath 120 has a viscosity. Accordingly, the viscous sheath 120 may be adhered to the power reception body 190 or a mounting surface due to its viscosity. The viscous sheath 120 may be made of either a polyurethane material or a silicon material, or made of a composite material of both the polyurethane material and the silicon material. However, the present invention is not limited thereto, and can be applied to any other material having a viscosity other than the polyurethane or silicon material. However, in the present embodiment, it will be illustrated that the viscous sheath is made of a polyurethane material.

The polyurethane to form a viscous sheath according to the present embodiment may be formed through a polymerization of a main material 10 including a polyol that has at least two hydroxyl groups per one molecule and influences the viscosity of the viscous sheath 120, and a hardener 20 that contains an isocyanate compound and influences the elasticity of the viscous sheath 120.

In this case, the content of the polyol in the main material 10 may be adjusted to have a range from 75 weight percent to 95 weight percent, and the content of the isocyanate compound in the hardener 20 may be adjusted to have a range from 30 weight percent to 60 weight percent.

When the content of the polyol is 75 weight percent or more, the viscosity of the viscous sheath 120 may be increased such that the viscous sheath 120 made of the polyurethane can be adhered to the power reception body or the mounting surface.

Further, even when the viscosity of the viscous sheath 120 is lost as a dust is adhered to the polyurethane due to a prolonged use, the dust adhered to the polyurethane may be removed and the viscosity may be restored when the viscous sheath 120 is washed with neutral detergent or water. Thus, the viscous sheath 120 may be used repeatedly. Obviously, since the power transmission unit consisting of moisture-sensitive electronic components is sealed in the interior of the viscous sheath 120, there is no risk of moisture penetration when washing.

When the content of the polyol is 95 weight percent or less, the polyurethane P can be prevented from sticking to the adherend surface and causing contamination.

Further, since it is not necessary to apply a large external force in order to remove the polyurethane P from a bottom or a garment surface, a durability of the viscous sheath 120 can be improved.

Such a polyol may include at least one of an ether polyol and an ester polyol. In this case, the ether polyol is obtained by etherifying a propylene glycol.

Hereinafter, a method for implementing the main material 10 including the polyol of the polyurethane P to form the viscous sheath 120 will be described. The following description is intended to illustrate any one of various methods for implementing the present invention, and the present invention is not limited to the following description.

Hereinafter, a first example for implementing the main material 10 containing the polyol will be described. The polyol implementing the main material 10 according to this example may be used in a combination of polyols of at least two types. Further, it may use a first polypropylene glycol that has a molecular weight ranging from 2500 to 3500, and has two hydroxyl groups per molecule, when a content within the main material 10 ranges from 13 weight percent to 40 weight percent, and a second polypropylene glycol that has a molecular weight ranging from 2500 to 5500, and has three hydroxyl groups per molecule, when a content within the main material 10 ranges from 40 weight percent to 77 weight percent.

In addition, the polyurethane P may be manufactured by adding a catalyst, a chain extender, and a plasticizer as an additive to the polyol including the first polypropylene glycol and the second polypropylene glycol.

The catalyst is used to expedite a compound reaction of the main material 10. Various catalysts generally known to an ordinary skilled person may be used as the catalyst. The catalyst may be added to the main material 10 so that the content of catalyst within the main material 10 may range from 0.2 weight percent to 12 weight percent so as to minimize a side reaction.

The chain extender has a functional group that can react to an isocyanate group which will be described later. Various chain extenders generally known to an ordinary skilled person may be used as the chain extender.

The chain extender may be added to the main material 10 so that the content of chain extender within the main material 10 may range from 0.1 weight percent to 13 weight percent so as to increase the cohesion of the polyurethane P.

In addition, a plasticizer may be mixed as a remainder.

Hereinafter, a method for implementing any one of the hardener 20 including the above-described isocyanate compound will be described.

The isocyanate implementing the hardener 20 mixed with the main material 10 according to the above mentioned first example may be used in a combination of at least two types of isocyanate compound. Further, it may use a toluene diisocyanate when a content within the hardener 20 ranges from 29 weight percent to 49 weight percent, and a hexamethylene diisocyanate when a content within the hardener 20 ranges from 32 weight percent to 52 weight percent.

In addition, the hardener 20 may be manufactured by adding a third polypropylene glycol that has a molecular weight ranging from 2500 to 3500, and has three hydroxyl groups per molecule when a content within the hardener 20 ranges from 5 weight percent to 20 weight percent, and a plasticizer as a remainder, to the isocyanate compound including toluene diisocyanate and hexamethylene diisocyanate.

Hereinafter, a second example for implementing the main material including a polyol will be described.

The polyol implementing the main material may be used in a combination of at least two types of polyol.

Further, it may use a polyester polyol that has a molecular weight ranging from 1500 to 2500 when a content within the main material 10 ranges from 30 weight percent to 50 weight percent, and a polyol that has a molecular weight ranging from 3500 to 5500, and has three hydroxyl groups per molecule when a content within the main material 10 ranges from 25 weight percent to 45 weight percent.

In addition, the main material 10 may be manufactured by adding a catalyst, a chain extender, and a plasticizer as an additive to the polyester polyol and the polyol.

The catalyst is used to expedite a compound reaction of the main material 10. Various catalysts generally known to an ordinary skilled person may be used as the catalyst. The catalyst may be added to the main material 10 so that the content of catalyst within the main material 10 may range from 0.2 weight percent to 12 weight percent so as to minimize a side reaction.

The chain extender has a functional group that can react to an isocyanate group which will be described later. Various chain extenders generally known to an ordinary skilled person may be used as the chain extender.

The chain extender may be added to the main material 10 so that the content of chain extender within the main material 10 may range from 0.5 weight percent to 1.5 weight percent so as to increase the cohesion of the polyurethane P.

In addition, a plasticizer may be mixed as a remainder.

Meanwhile, when the content of the isocyanate compound is 30 weight percent or more, the elasticity of the polyurethane P can be increased. Accordingly, a volume of viscous sheath 120 squashed by the power reception body may be easily restored to an original shape such that plastic deformation in a direction of external force may not occur.

In addition, when the content of the isocyanate compound is 60 weight percent or more, polyurethane P does not become hard and has excellent cushioning such that it can be more tightly adhered to a curved wall surface, and a console or a dashboard of the vehicle.

Such isocyanate compound may include at least one of hexa-methylene-diisocyanate, methylene-diisocyanate, toluene-diisocyanate, and isoprene-diisocyanate.

Hereinafter, another method for implementing a hardener 20 including the above-described isocyanate compound will be described.

The toluene diisocyanate may be solely used for the isocyanate compound implementing the hardener 20 mixed with the main material 10 according to the above-described second example.

Thus, as the polyurethane P applied to the viscous sheath 120 according to an embodiment of the present invention is manufactured by mixing the above-described main material 10 with the hardener 20 to accomplish polymerization, it may have a bond strength that does not damage an adherend surface, a rich viscosity that may be used repeatedly even when it is washed with a neutral detergent or water, and an excellent elasticity that enables a volume of the polyurethane squashed by the power reception body and a mounting surface to restore to an original shape

Meanwhile, user may adjust the viscosity and the elasticity of the viscous sheath 120 by adjusting the mixing ratio or the molecular weight of the main material 10 and the hardener 20 or by adjusting the amount of addition.

For example, the viscous sheath 120 may require a strong viscosity so as to maintain the adherement of the fan 196 having a relatively heavy weight or the smart phone 192 which may probably be damaged when being dropped.

Therefore, user may manufacture the polyurethane P according to an embodiment for manufacturing the viscous sheath 120 with a strong viscosity.

Meanwhile, the viscous sheath 120 may require a weak viscosity so as to maintain the adherement of the lamp 194 having a relatively light weight. Therefore, user may manufacture the polyurethane P according to an embodiment for manufacturing the viscous sheath 120 with such a viscosity.

That is, user may manufacture polyurethane P having a different viscosity to selectively use it for the viscous sheath 120.

Hereinafter, a method of manufacturing an adhesive wireless power supply apparatus according to an embodiment of the present invention will be described.

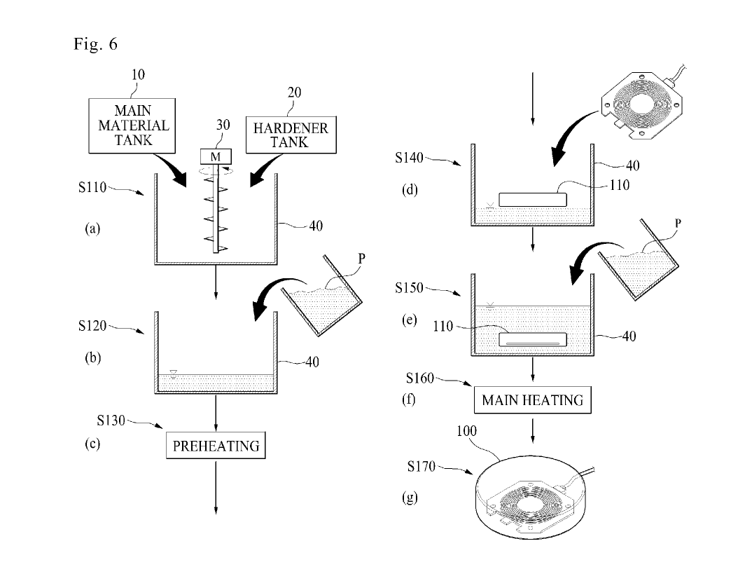

As shown in FIG. 6, the method of manufacturing an adhesive wireless power supply apparatus according to an embodiment of the present invention may include an agitation step S110, a first injection step S120, a preheating step S130, a power transmission unit arrangement step S140, a second injection step S150, a main heating step S160, and a separation step S170.

As shown in FIG. 6A, the agitation step S110 may be a step of mixing the main material 10 stored in a main material tank with the hardener 20 stored in a hardener tank in an agitator 30.

In this case, the main material 10 and the hardener 20 may be a composition manufactured through the above mentioned example 1 or example 2.

The main material 10 and the hardener 20 injected to the agitator 30 may be agitated by the agitator 30, and a mixing of the main material 10 and the hardener 20 may be uniformly accomplished by the agitation to cause a polymerization.

In addition, the polyurethane P that completed the agitation contains a lot of air bubbles, which may deteriorate aesthetic sense. Hence, a defoamation step (not shown) of removing the air bubbles generated at the agitation step S110 may be further included. Obviously, the defoamation step may not be performed, if necessary.

In addition, as shown in FIG. 6B, the first injection step S120 is a step of injecting some of the polyurethane P implemented by the polymerization of the main material 10 and the hardener 20 at the agitation step S110 into the inside a mold 40.

Meanwhile, the mold 40 is used to form the viscous shell 120, and an internal space for receiving the polyurethane P may be formed in a shape and a size of the viscous sheath 120.

In this case, the amount of the polyurethane P injected at the first injection step S120 may be an amount of forming part of an upper side (a side in contact with a power transmission unit) of the viscous sheath 120.

Then, the preheating step S130 may be performed. As shown in FIG. 6C, the preheating step S130 is a step of provisionally hardening the polyurethane P injected at the first injection step S120 by heating.

The polyurethane P in which the main material 10 and the hardener 20 are agitated at the agitation step S110 may be hardened as it is heated.

In this step, it is not necessary to completely harden the polyurethane P, and may be hardened to have a hardness enough to support the weight of the power transmission unit 110 described later.

As shown in FIG. 6D, the power transmission unit arrangement step S140 is a step of disposing the power transmission unit 110 to an upper portion of the polyurethane P provisionally hardened at the preheating step S130.

In addition, as shown in FIG. 6E, the second injection step S150 is a step of injecting the polyurethane P implemented by the polymerization of the main material 10 and the hardener 20 at the agitation step S110 on an upper portion of the power transmission unit 110, in the inside the mold 40.

As shown in FIG. 6F, the main heating step S160 is a step of hardening the polyurethane P injected at the second injection step S150 is hardened in the inside of the mold 40 by heating, together with the polyurethane P provisionally hardened at the preheating step S130

At the main heating step S160, the polyurethane P within the mold 40 may be completely hardened as needed.

In this case, a temperature of heating for the purpose of hardening the polyurethane P at the main heating step S160 may be lower than a heat resistant temperature of the power transmission coil 112 of the power transmission unit 110 and electronic components mounted in the circuit board 114.

In general, considering that the heat resistant temperature of electronic components is 80 degrees centigrade, at the preheating step S130 and the main heating step S160, it may be heated with a temperature ranging from 30° C. to 70° C. such that the electronic components implementing the power transmission unit 110 may not be damaged.

Further, the polyurethane P which was injected at the first injection step S120 goes through two heating processes of the preheating step S130 and the main heating step S160 such that its viscosity may be weaker than the viscosity of the polyurethane injected at the first injection step S120 that went through a single heating process.

Therefore, the viscosity of a surface of the viscous sheath 120 in contact with a mounting surface may be implemented to be stronger than the viscosity of a surface of the viscous sheath 120 in contact with the power reception body 190.

When the hardening of the polyurethane P is completed at the main heating step S160, the separation step S170 may be performed. As shown in FIG. 6G, the separation step S170 is a step of demolding the viscous sheath 120 consisting of the hardened polyurethane and the power transmission unit 110 from the mold 40.

Hereinafter, an adhesive wireless power supply apparatus 300 according to a third embodiment of the present invention will be described.

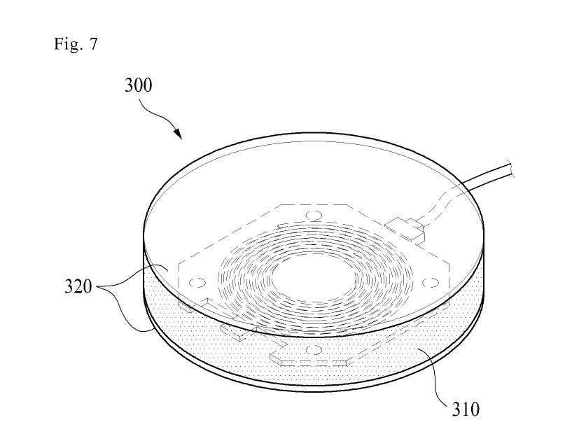

As shown in FIG. 7, the adhesive wireless power supply apparatus 300 according to this embodiment of the present invention may include a power transmission unit 310 and a viscous unit 320.

The power transmission unit 310 is substantially similar to the power transmission unit 110, 210 of the above described first and second embodiments. However, the power transmission unit 110, 210 of the above described first and second embodiments does not require a separate housing, such as a plastic, as the viscous sheath 120, 220 serves as a substantial housing. However, the power transmission unit 310 according to the present embodiment may be provided with a housing surrounding the power transmission coil and the circuit board.

In addition, the viscous unit 320 may be formed of the same material as the viscous sheath 120, 210 of the above described first and second embodiments, and may be provided on both of a surface of the power transmission unit 310 in contact with the power reception body 190 and a surface of the power transmission unit 310 in contact with the mounting surface.

Therefore, due to the viscosity and the elasticity of the viscous unit 320, the power reception body 190 may be adhered and fixed to the power transmission unit 310, or the power transmission unit 310 may be adhered and fixed to various mounting surfaces.

At this time, a thickness of the viscous unit which is provided on the surface in contact with the power reception body 190 ranges from 1 to 3 mm among the viscous unit 320 provided on the surface of the power transmission unit 310 in contact with the power reception body 190 and the surface of the power transmission unit 310 in contact with the mounting surface.

Meanwhile, in the present embodiment, it is illustrated that the viscous unit 320 is provided on both the surface of the power transmission unit 310 in contact with the power reception body 190 and the surface of the power transmission unit 310 in contact with the mounting surface, but the present invention is limited thereto. Although not shown in drawing, the viscous unit 320 may be provided only on the surface of the power transmission unit 310 in contact with the power reception body 190.

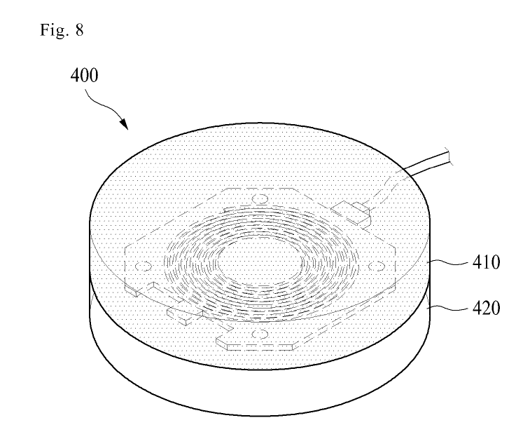

Alternatively, as shown in an adhesive wireless power supply apparatus 400 according to a fourth embodiment of the present invention of FIG. 8, a viscous unit 420 may be provided only on a surface of a power transmission unit 410 in contact with the mounting surface.

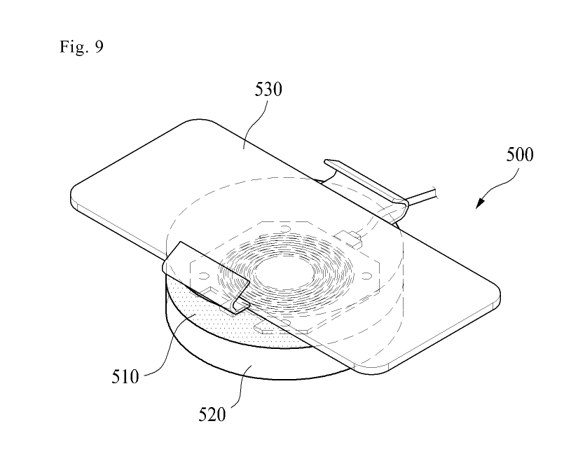

Alternatively, as shown in an adhesive wireless power supply apparatus 500 according to a fifth embodiment of the present invention of FIG. 9, a viscous unit 520 may be provided only on a surface of a power transmission unit 510 in contact with the mounting surface, whereas a holder 530 to fix a portable terminal, such as a smartphone 192, may be provided on a surface of the power transmission unit 310 in contact with the power reception body 190. Such a holder 530 may be differentiated according to a type and a shape of the power reception body 190.

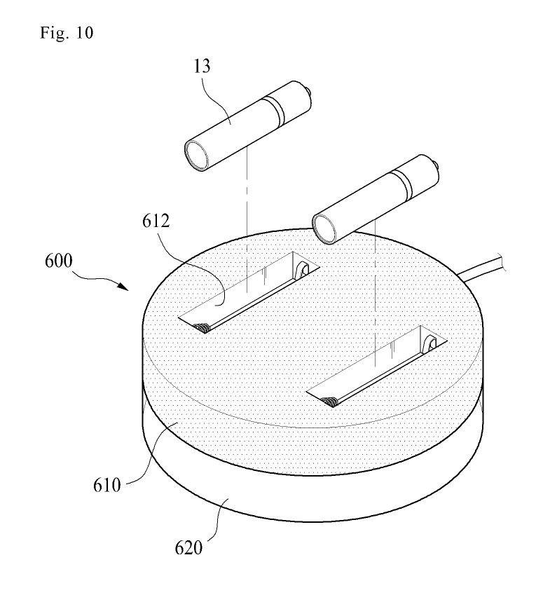

Alternatively, as shown in an adhesive wireless power supply apparatus 600 according to a sixth embodiment of the present invention of FIG. 10, a battery compartment 612 for holding a battery B may be further provided so as to supply power to a power transmission unit 610 through the battery B instead of an external power.

Hence, even in a place where external power is not provided, the power reception body 190 may be provided with the power through the battery B to be charged or used.

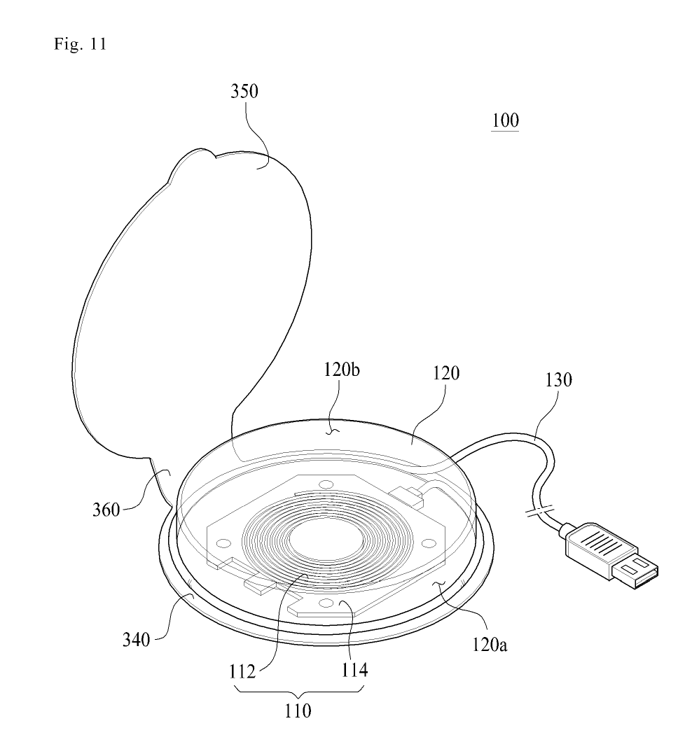

FIG. 11 is a perspective view illustrating another adhesive wireless power supply apparatus according to an embodiment of the present invention.

As shown in FIG. 11, the adhesive wireless power supply apparatus 100 according to an embodiment of the present invention may include a base 340, a power transmission unit 110, a viscous sheath 120, and a cover 350.

The power transmission unit 110 may include a power transmission coil 112 that generates an induce power in a power reception coil (not shown) provided in a power supply target object and a circuit board 114, in which the power transmission coil is mounted, that receives power from an external and supplies power to the power transmission coil.

That is, the target object to receive power through the power transmission unit 110 according to an embodiment of the present invention may be, for example, an electronic device such as a mobile phone, a lamp, or a fan. In addition, such a power supply target object may be an electronic device provided with a power reception coil.

The viscous sheath 120 is formed to surround the outside of the power transmission unit 110, and, as it is made of a material with a viscosity and elasticity, one surface 120A may be adhered to the base 340.

The viscous sheath 120 according to an embodiment of the present invention may be adhered to the power supply target object by using viscosity. In addition, it may be adhered directly to the mounting surface due to the viscosity.

Further, in the mounting surface that cannot be adhered by the viscosity of the viscous sheath 120 of the adhesive wireless power supply apparatus of the present invention, a first fix panel and a second fix panel which will be described later may be used to implement attachment to the mounting surface.

The cover 350 may be combined to one side of the base 340, and may be provided to open or cover the other surface 120B of the viscous sheath 120.

In this case, a crease unit 360 may be provided between the cover 350 and the base 340, and the cover 350 may be combined to the base 340 through the crease unit 360, and folded or unfolded to cover or open the other surface 120B of the viscous sheath 120.

Meanwhile, a cable 130 extended to the outside of the viscous sheath 120 from the power transmission unit 110 may be further included to supply external power to the power transmission unit.

When the cable is wound around the viscous sheath as the power transmission unit is not used, the cable can be adhered to the circumference of the viscous sheath due to the viscosity of the viscous sheath. Thus, the adhesive wireless power supply apparatus can be conveniently carried as the cable is easily arranged.

Meanwhile, since the power transmission unit can be protected from an impact of external force due to an elasticity of the viscous sheath 120, a damage of the power transmission unit can be prevented.

Further, the adhesive wireless power supply apparatus according to an embodiment of the present invention may wrap up the viscous sheath 120 by using the base 340 and the cover 350, it can be prevented that the viscosity of the viscous sheath is deteriorated due to a foreign matter like a dust.

In this manner, the adhesive wireless power supply apparatus according to an embodiment of the present invention may be adhered to an object through the viscous sheath, thereby capable of supplying power to the object in various environments. Further, the object and the power transmission unit may maintain a fixed position by using the viscosity of the viscous sheath, thereby capable of supplying power stably to the object.

Meanwhile, since the viscous sheath has a viscosity, it may be made of either of a polyurethane material or a silicon material, or made of a composite material of both the polyurethane material and the silicon material that are adhered to the base 340 and the cover 350 due to its viscosity. However, the present invention is not limited thereto, and can be applied to any other material having a viscosity other than the polyurethane or silicon material.

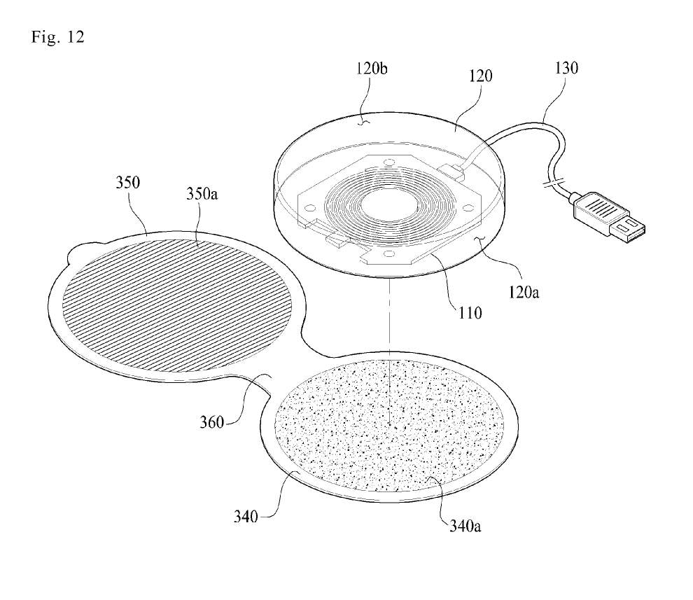

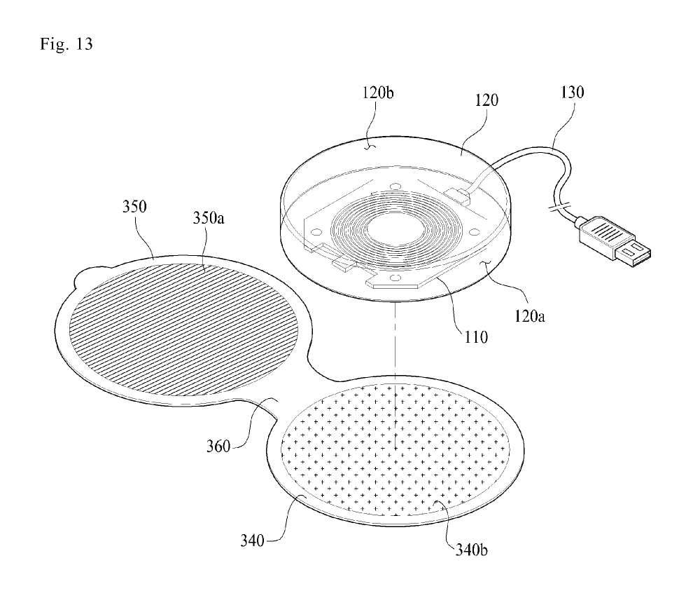

FIG. 12 and FIG. 13 are diagrams illustrating an example of a base and a cover according to an embodiment of the present invention. As described above, the viscosity of one surface 120A of the viscous sheath 120 adhered to the base 340 may be stronger than the viscosity of the other surface 120B of the viscous sheath 120 adhered to the cover 350.

Meanwhile, the surface of the base may be modified so as to enhance the viscosity of one surface 120A of the viscous sheath 120 adhered to the base 340.

Accordingly, a corona 340A treatment may be performed or a primer 340B may be coated with respect to the surface of the base to which the viscous sheath is adhered so that the viscous sheath may be adhered to the base 340 due to viscous sheath's inherent viscosity.

However, the present invention is not limited thereto, but other processing methods other than the corona 340A treatment and the primer 340B coating may be applied.

Both of the primer coating and the corona treatment may be a method for modifying the surface of object so as to ensure that the viscous sheath is smoothly adhered to the base 340.

The primer coating may be a method of coating a primer, which is a surface treatment agent, to a surface so as to enhance a viscosity, and the corona treatment may be a method for modifying a surface by generating a corona salt using a corona processor.

As described above, the one surface 120A of the viscous sheath may be adhered to the base, and a power supply target object may be adhered to the other surface 120B of the viscous sheath. In this case, the viscous sheath may not be detached from the base due to the viscosity of the viscous sheath, even though the viscous sheath is loaded by the power supply target object.

Meanwhile, as shown in FIG. 12 and FIG. 13, the surface of the cover to which the viscous sheath is adhered may be provided with a release paper 350A or a release coating so that the cover 350 may be easily detached from the viscous sheath 120.

The surface of the cover provided with the release paper 350A or the release coating may be connected to the viscous sheath to protect the other surface of the viscous sheath from a foreign matter such as dust when no target object is adhered to the viscous sheath.

Thus, user may easily carry the adhesive wireless power supply apparatus of the present invention in real life, and supply power to the target object.

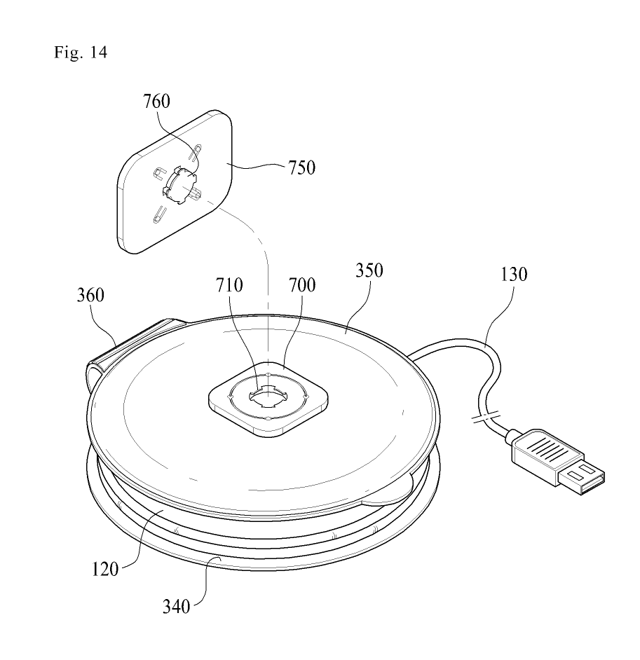

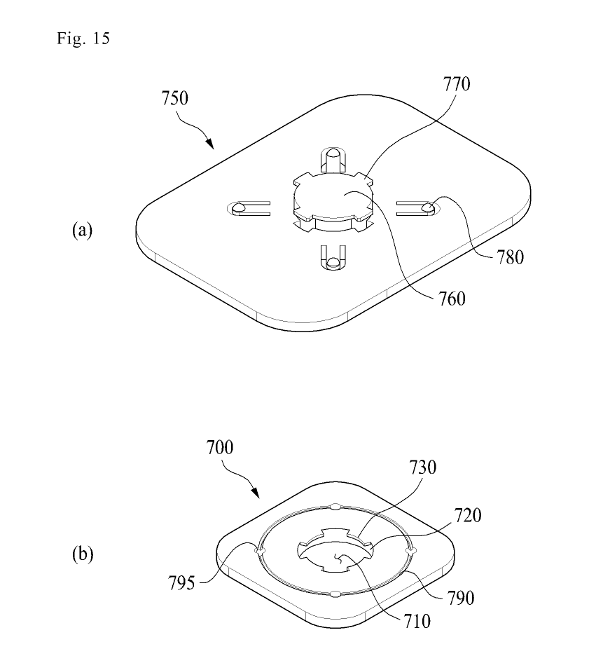

Meanwhile, as shown in FIG. 14 and FIG. 15, the adhesive wireless power supply apparatus according to an embodiment of the present invention may be adhered to the mounting surface through a first fix panel 700 and a second fix panel 750 in an environment in which the viscous sheath is difficult to be adhered or a power supply unit is semipermanently adhered to use.

The first fix panel 700 may be provided in any one of the outer surface of the base 340 or the cover 350, and may include an insertion unit 710 penetrating a surface.

The second fix panel 750 may include one side unit and the other side unit, and the one side unit of the second fix panel 750 may include a fastening unit 760 that is detachably coupled to the insertion unit 710, and the other side unit of the second fix panel 750 may be adhered to the mounting surface.

The other side unit of the second fix panel 750 may be provided with an adhesive member for fixing having a strong viscosity.

Accordingly, the second fix panel 750 may be permanently or semi-permanently adhered to a fixed position or the mounting surface which is difficult to adhere by using the viscosity of the viscous sheath 120.

When the second fix panel 750 is adhered to the mounting surface by the user, the adhesive wireless power supply apparatus of the present invention may be adhered to the mounting surface by coupling the first fix panel 700 provided in any one of the base 340 or the cover 350 to the second fix panel 750.

Accordingly, the power supply target object may be supplied with a power by being adhered to the viscous sheath 120 in a state in which the adhesive wireless power supply apparatus of the present invention is adhered to the mounting surface.

Looking specifically for the first fix panel 700 and the second fix panel 750, as shown in FIG. 15, the insertion unit 710 of the first fix panel 700 may include a first inlet 720 and a first protrusion unit 730, wherein the fastening unit 760 of the second fix panel 750 corresponds to the first inlet 720, and a second protrusion unit 770 which is inserted into the insertion unit 710 through the first inlet 720 and rotates to be coupled to the first protrusion unit 730.

That is, when user rotates the second fix panel 750 after inserting the second protrusion unit 770 into the insertion unit 710 through the first inlet 720, the second protrusion unit 770 may be coupled to an inner surface of the first protrusion unit 730.

Therefore, as the first fix panel 700 and the second fix panel 750 are combined, the adhesive wireless power supply apparatus according to an embodiment of the present invention may be adhered to the mounting surface through the base 340 or the cover 350.

In this case, a position where the first fix panel 700 and the second fix panel 750 are combined may be designated so that an object adhered to the viscous sheath 120 may be adhered in a proper place.

Accordingly, the second fix panel 750 may include a protuberance 780 which is elastically deformed, and one side of the first fix panel 700 adhered to the second fix panel 750 may include a guideline 790 that guides movement of the protuberance 780 and a fixing hole 795 that indicates a position in which a rotation of the protuberance 780 is stopped.

However, the protuberance 780 and the fixing hole 795 are a configuration to indicate the proper place of the object to be adhered to the viscous sheath 120, and does not disturb the rotation of the fastening unit 760.

Accordingly, when the fastening unit 760 is continuously rotated, the protuberance 780 may pass through the fixing hole 795 and may be separated from the insertion unit 710 via another first inlet 720.

Thus, the adhesive wireless power supply apparatus according to an embodiment of the present invention may be adhered to the mounting surface of various materials in various environments through the first fix panel 700 and the second fix panel 750.

Meanwhile, as described above, the object supplied with power through the adhesive wireless power supply apparatus according to an embodiment of the present invention may be an electronic device such as a fan, a lamp, or a mobile phone.

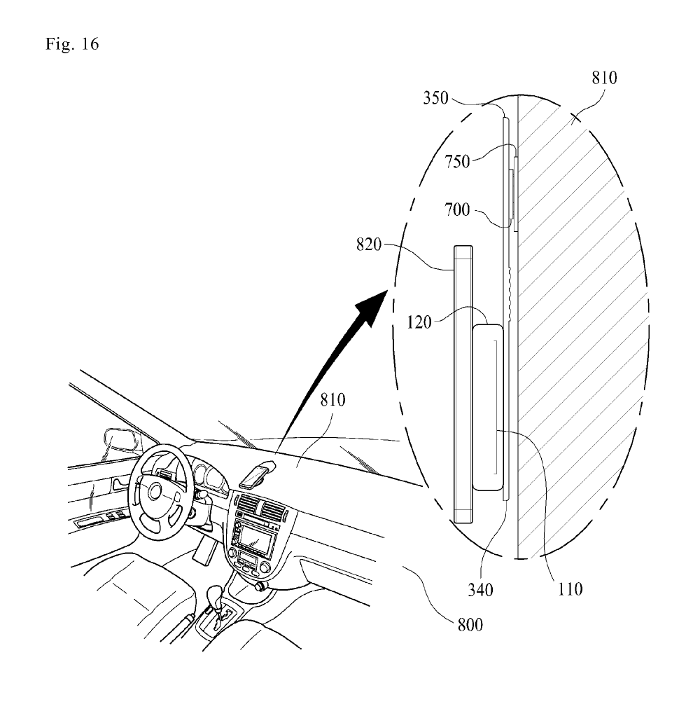

Hereinafter, the mounting of the mobile phone will be illustrated as an example of the mounting of the above mentioned adhesive wireless power supply apparatus according to an embodiment of the present invention. As shown in FIG. 16, the adhesive wireless power supply apparatus of the present invention may be adhered to a dashboard 810 of a vehicle 800.

For example, if a mobile phone 820 is used as a navigation device, the power consumption may be increased such that the operating time of mobile phone 820 may be shortened.

Hence, the mobile phone 820 may be adhered to the viscous sheath 120 after the adhesive wireless power supply apparatus of the present invention is adhered to the dashboard 810 of the vehicle 800 so that the mobile phone 820 may be supplied with power while the mobile phone 820 operates.

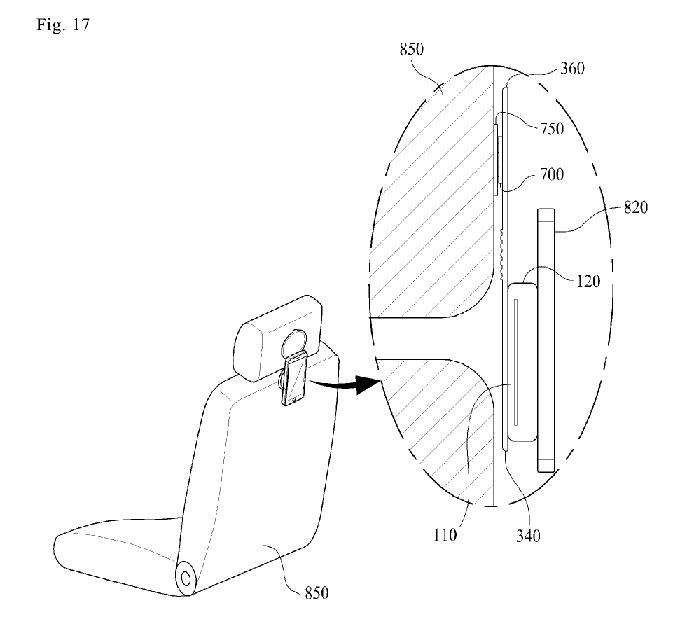

Alternatively, as shown in FIG. 17, a child or company may watch the mobile phone 820 during a long distance movement by adhering the adhesive wireless power supply apparatus of the present invention to the back of a front seat 850.

In this case, the mobile phone 820 may also be supplied with power while user watches the mobile phone 820, such that the operating time of the mobile phone 820 may be increased.

Further, when an external force such as a sudden stop of vehicle is applied to the mobile phone 820, the mobile phone 820 may be prevented from being damaged due to the elasticity of the viscous sheath 120.

Accordingly, the adhesive wireless power supply apparatus of the present invention may supply power to various objects in various environments by using inherent viscosity, and may supply power stably to the power supply target object by preventing the object from being shaken.

In addition, the power transmission unit 110 may be protected from impact exerted from the outside, direct sunlight, high temperature, moisture, and dust.

The adhesive wireless power supply apparatus of the present invention and the manufacturing method thereof has following effects.

First, since the power reception unit, such as a portable terminal or a lamp, may be adhered and fixed to the power transmission unit due to the viscous sheath, the arrangement of the adhesive wireless power supply apparatus of the present invention may not be disturbed even if a vibration or an unexpected external force is applied, such that the power reception coil and the power transmission coil can be arranged in a proper place to achieve the power transmission smoothly.

Second, since a disturbance of the power reception coil and the power transmission coil is prevented even when a vibration or an unexpected external force is applied, the charging may be achieved in a place such as a vehicle in which the vibration or the external force is frequently or always applied.

Third, since the power transmission unit is surrounded by the viscous sheath, the adhesive wireless power supply apparatus of the present invention may be adhered to a wall as well as a desk due to the viscosity of the viscous sheath, and may be used with a desired fixed position and angle while being charged when the smartphone is required to use for a long time e.g., watching movie with charging.

Fourth, since the power reception unit is not limited to a portable terminal, but may be applied to an object which is not heavy such as a lamp or a fan, or the like equipped with a power reception coil, various types of power reception unit such as the lamp or the fan, or the like may be adhered to a desired position and used.

Fifth, since the viscous sheath is formed of a material having elasticity, it is able to protect the power transmission unit from impact applied from the outside, direct sunlight, high temperature, or humidity, or the like.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An adhesive wireless power supply apparatus, comprising:
a power transmission unit including a power transmission coil to generate an induced power in a power reception coil provided in a power reception body and a circuit board, in which the power transmission coil is mounted, supplied with power from an external, and provides power to the power transmission coil; and
a viscous sheath which is formed to surround the outside of the power transmission unit, is made of a material having viscosity and elasticity, is adhered to the power reception body due to an inherent viscosity, and enables the power transmission unit to be adhered to a mounting surface.

2. The apparatus of claim 1, wherein the viscous sheath has a shape of cylinder.

3. The apparatus of claim 2, wherein a groove in which a cable to supply power to the power transmission unit is wound on an outer periphery of the viscous sheath.

4. The apparatus of claim 1, wherein a viscosity of a surface of the viscous sheath in contact with a mounting surface is implemented to be stronger than a viscosity of a surface of the viscous sheath in contact with the power reception body.

5. The apparatus of claim 1, further comprising a base in contact with one surface of the viscous sheath and a cover provided to open or cover the other surface of the viscous sheath.

6. The apparatus of claim 5, wherein a corona treatment is performed or a primer is coated on the surface of base in contact with the viscous sheath.

7. The apparatus of claim 5, further comprising:
a first fix panel provided in any one of an outer surface of the base or the cover, and includes an insertion unit penetrating a surface; and
a second fix panel includes one side unit including a fastening unit that is detachably coupled to the insertion unit and the other side unit adhered to the mounting surface.

8. The apparatus of claim 7, wherein the insertion unit comprises:
a first inlet and a first protrusion unit when the fastening unit corresponds to the first inlet; and
a second protrusion unit which is inserted into the insertion unit through the first inlet and rotates to be coupled to the first protrusion unit.

9. The apparatus of claim 7, wherein the second fix panel comprises a protuberance which is elastically deformed, and one side of the first fix panel includes a guideline that guides movement of the protuberance and a fixing hole to stop a rotation of the protuberance.

10. An adhesive wireless power supply apparatus, comprising:
a power transmission unit including a power transmission coil to generate an induced power in a power reception coil provided in a power reception body and a circuit board, in which the power transmission coil is mounted, supplied with power from an external, and provides power to the power transmission coil; and
a viscous sheath which is formed to surround the outside of the power transmission unit, and is made of a viscous polyurethane having viscosity and elasticity, wherein a heating temperature is lower than a heat resistant temperature of the power transmission unit 110 when the viscous polyurethane is moulded.

11. The apparatus of claim 10, wherein the viscosity polyurethane is formed through a polymerization of a main material including a polyol that has at least two hydroxyl groups per one molecule and a hardener that contains an isocyanate compound, and the content of the polyol in the main material has a range from 75 weight percent to 95 weight percent, and the content of the isocyanate compound in the hardener 20 has a range from 30 weight percent to 60 weight percent.

12. The apparatus of claim 11, wherein the isocyanate compound comprises at least one of hexa-methylene-diisocyanate, methylene-diisocyanate, toluene-diisocyanate, and isoprene-diisocyanate.

13. The apparatus of claim 11, wherein the main material comprises:
a first polypropylene glycol that has a molecular weight ranging from 2500 to 3500, and has two hydroxyl groups per molecule, when a content within the main material ranges from 13 weight percent to 40 weight percent;
a second polypropylene glycol that has a molecular weight ranging from 2500 to 5500, and has three hydroxyl groups per molecule, when a content within the main material ranges from 40 weight percent to 77 weight percent;
a catalyst whose content within the main material ranges from 0.2 weight percent to 12 weight percent; and
a chain extender whose content within the main material ranges from 0.1 weight percent to 13 weight percent and a plasticizer as a remainder.

14. The apparatus of claim 11, wherein the hardener comprises:
a toluene diisocyanate whose content within the hardener ranges from 29 weight percent to 49 weight percent;
a hexamethylene diisocyanate whose content within the hardener ranges from 32 weight percent to 52 weight percent; and
a third polypropylene glycol that has a molecular weight ranging from 2500 to 3500, and has three hydroxyl groups per molecule when a content of third polypropylene glycol within the hardener 20 ranges from 5 weight percent to 20 weight percent, and a plasticizer as a remainder

15. An adhesive wireless power supply apparatus, comprising:
a power transmission unit including a power transmission coil to generate an induced power in a power reception coil provided in a power reception body, and a circuit board which is equipped with the power transmission coil and provides power to the power transmission coil; and
a viscous unit which is provided on at least one of a surface of power transmission unit in contact with a power reception body or a surface of power transmission unit in contact with a mounting surface, is made of a material having viscosity and elasticity, and enables the power reception body to be adhered or the power transmission unit to be adhered to a mounting surface due to an inherent viscosity.

16. The apparatus of claim 15, wherein the viscous unit is disposed on the surface of power transmission unit in contact with the mounting surface, further comprising a holder which is provided on a surface of power transmission unit in contact with the power reception body, and is provided to fix the power reception body.

17. The apparatus of claim 15, further comprising a cable to supply an external power to the power transmission unit.

18. The apparatus of claim 15, further comprising a battery compartment which is formed in the power transmission unit, and holds a battery to supply power to a power transmission unit.
